(19) United States
(12) Patent Application Publication
(10) Pub. No.: US 2004/0151121 A1
(43) Pub. Date: Aug. 5, 2004

(54) Method of determining a maximal mesh

(76) Inventors: Srikanth Natarajan, Fort Collins, CO (US); Dipankar Gupta, Fort Collins, CO (US); Anthony Paul Michael Walker, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/354,991

(22) Filed: Jan. 31, 2003

(51) Int. Cl. H04J 1/16; H04L 12/28

(52) U.S. Cl. 370/252; 370/400

(57) ABSTRACT

A method of determining maximal meshes in a network is described. Topology information is examined to determine multiple, maximal meshes in a computer network. In one embodiment, all of the multiple, maximal meshes in the computer network are determined. Mesh data is stored indicating the multiple maximal meshes.

### RELATED APPLICATIONS

The present application is related to the U.S. applications “METHOD OF DETERMINING A MESH IN A COMPUTER NETWORK”, Walker et al., Ser. No. ______, (Attorney Docket No. 100202326); “METHOD OF INDICATING A PATH IN A COMPUTER NETWORK”, Walker et al., Ser. No. ______, (Attorney Docket No. 100202822-1); and “METHOD OF STORING DATA CONCERNING A COMPUTER NETWORK”, Ho et al., Ser. No. ______ (Attorney Docket No. 100204008). Each of these applications is filed on the same day as the present application and is incorporated herein by reference.

### BACKGROUND

Computer networks can include meshes of nodes, such as switches, that provide redundancy for the computer network. A mesh is a group of at least three nodes that are fully interconnected. A failure in network operation when one of the nodes fails can be avoided by rearranging the data transfer through the network because of the redundancy provided by the mesh. For example, in an Ethernet switching environment, a spanning tree defined within the computer network can be rearranged to avoid a failure at a node in a mesh.

### SUMMARY

In accordance with exemplary embodiments, a method of determining a maximal mesh is disclosed. Topology information is examined to determine multiple, maximal meshes in a network. Mesh data is stored that indicates the multiple maximal meshes.

In accordance with the exemplary embodiments of the present invention, a computer for determining a maximal mesh is disclosed. The computer comprises a means for examining topology information to determine multiple, maximal meshes in the computer network. The computer also includes a means for storing mesh data that indicates the multiple maximal meshes.

Exemplary embodiments are also directed to a computer readable medium containing a program which executes the following procedure for determining a maximal mesh: examining topology information to determine maximal meshes in a network; and storing mesh data that indicates the multiple, maximal meshes.

### BRIEF DESCRIPTION OF THE DRAWINGS

The accompanying drawings provide visual representations which will be used to more fully describe the representative embodiments disclosed herein and can be used by those skilled in the art to better understand them and their inherent advantages. In these drawings, like reference numerals identify corresponding elements and:

FIG. 1 is a flowchart illustrating determining maximal meshes in a network according to an exemplary embodiment.

FIG. 2 is a diagram of a computer configured to determine maximal meshes in a network.

FIG. 3 is a diagram that illustrates an example of a network containing meshes.

FIG. 4 is a functional diagram that illustrates the operation of a mesh determination unit.

### DETAILED DESCRIPTION OF THE PREFERRED EMBODIMENTS

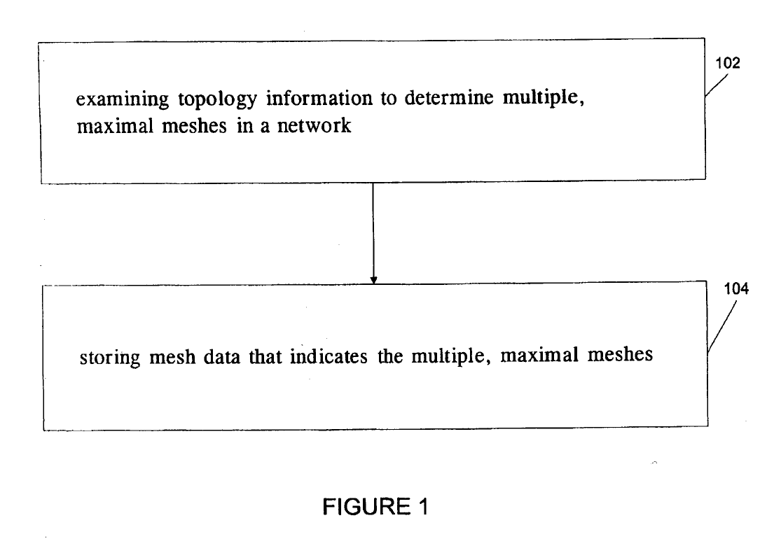

FIG. 1 is a flowchart for determining a maximal mesh. In Step 102, topology information is examined to determine multiple, maximal meshes in a network. The topology information can include information concerning the interconnection of nodes. The nodes can be physical units or stored representations. The nodes, such as switches, can be part of a network, such as a computer network. The nodes can include, but are not limited to: end nodes; routing nodes, such as routers using IP addresses; and switching non-routing nodes, such as switches using link level addresses. For the purposes of this patent application, a “computer network” is any network or subnetwork that interconnects nodes (e.g., computers). In one example, the computer network is a subnetwork of switching, nonrouting nodes. The nodes can also be stored representations of interconnected units such as in a graph.

For the nodes forming a mesh within a given network configuration, the mesh is considered to be maximal when it includes the largest possible number of fully interconnected nodes (that is, there are no additional nodes which are fully connected to the nodes of the mesh). For example, nodes A, B, and C can be fully connected with one another and be a mesh. However, if nodes A, B, and C are also fully connected to node D, then mesh {A, B, C} is not a maximal mesh.

The topology information can include the interconnections of the nodes, such as the nodes in a computer network. Topology information can thus be obtained that indicates which nodes in the network are interconnected. In one embodiment, interface information about the interconnection between the different interfaces in a computer network is obtained, and this interface information is used to produce node information indicating the interconnections between the nodes in the computer network.

In step 104, mesh data is stored that indicates the multiple maximal meshes. The mesh data can be stored in a memory or other location.

Thus, during the step of examining, candidate nodes can be evaluated to determine whether the nodes interconnect with all other nodes in a fully connected group of nodes. Indications of fully connected groups of nodes can be maintained for use in evaluating candidate nodes.

If a candidate node interconnects with all nodes in a fully connected group of nodes, the candidate node can be added to the fully connected group. Multiple indications of the fully connected group of nodes can be maintained during the examination process.

In one example, when no other node can be added to a fully connected group, and there are three or more nodes in the fully connected group, the fully connected group is indicated as being a maximal mesh. The maximal mesh can be indicated using the stored mesh data.

A fully connected group can also be evaluated to determine whether it is a subset of a larger mesh. In one example, indications of maximal meshes are stored, and a fully connected group of nodes that is a subset of another mesh is not separately indicated as a maximal mesh.

The examining of the topology information can be performed using a computer program. The computer program can be used to test possible arrangements of meshes in order to determine maximal meshes.

In one embodiment, the computer program uses recursion. Recursion is a way to test each possible combination of nodes to find the maximal meshes.

In one embodiment, the computer program can keep track of multiple fully connected groups. By keeping track of multiple fully connected groups, the computer program can determine the maximal meshes.

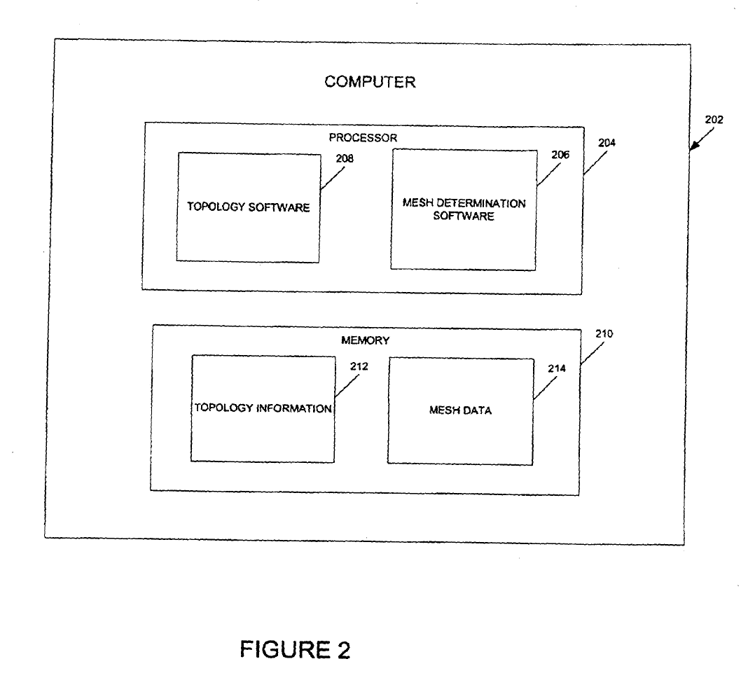

FIG. 2 illustrates a computer system for determining a maximal mesh according to an exemplary embodiment. In the example of FIG. 2, computer 202 includes a means, represented as a processor 204, for examining topology information. The processor is configured to examine the topology information to determine multiple maximal meshes in a network, such as a computer network. The computer 202 includes a means, represented as a memory 210, for storing mesh data that indicates the multiple maximal meshes.

In the example of FIG. 2, the processor 204 runs topology software 208 that receives topology information 212, processes the topology information 212, and stores the topology information 212 in the memory 210. The processor 204 also uses mesh determination software 206 to evaluate the topology information 212 and produce mesh data 214 to store in the memory 210, which can be any volatile or non-volatile memory.

The processor 204 can be configured to receive topology information that indicates which nodes in the computer network are interconnected.

The processor 204 can also be configured to evaluate one or more candidate nodes to determine whether a candidate node interconnects with all nodes in a fully connected group of nodes. If the candidate node interconnects with all the nodes in the fully connected group of nodes, the candidate node can be added to a fully connected group.

If no other node can be added to the fully connected group and there are three or more nodes in the fully connected group, the fully connected group can be indicated as a maximal mesh.

The processor 204 can execute a computer program, such as mesh determination software 206. The computer program can use recursion. The use of recursion allows the computer program to process all the possible meshes. The computer program can keep track of multiple fully connected groups.

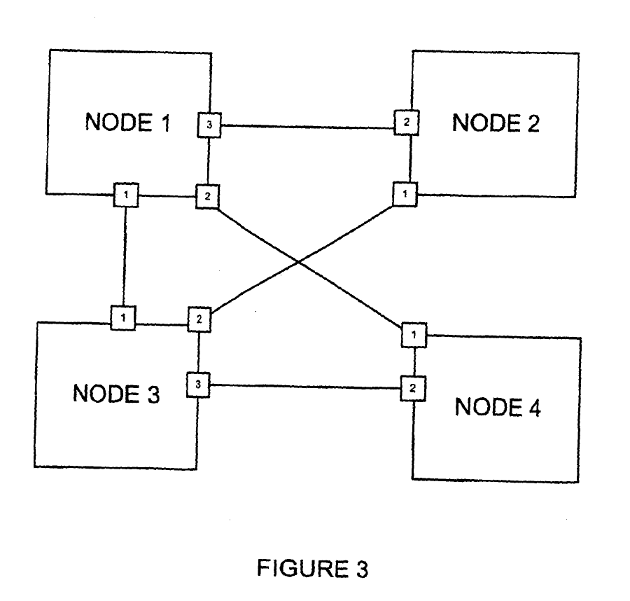

FIG. 3 illustrates an example of a network with four nodes, and can be used to illustrate how topology information can be examined for determining a maximal mesh. The FIG. 3 example can be defined by a global connectivity graph which illustrates the connectivity of the nodes in FIG. 3:

| | 1 | 2 | 3 | 4 |
|---|---|---|---|---|
| 1 | 0 | 1 | 1 | 1 |
| 2 | 1 | 0 | 1 | 0 |
| 3 | 1 | 1 | 0 | 1 |
| 4 | 1 | 0 | 1 | 0 |

The topmost row and the leftmost column, which are in bold, represent the nodes in the graph. The cells that are marked 0 indicate there is no connection between the nodes. For example, there is no connection between nodes 2 and 4. The cells that are marked 1 indicate there is a connection between the nodes. For example, there is a on between nodes 2 and 3. Connections are non-directional. This means if there is a connection between 1 and 4, it is assumed that there is a connection between 4 and 1 also. This will be represented by marking a one on the intersection of both row 1 column 4, and also on row 4 and column 1 in the matrix.

As an example, let “n” be the total number of nodes in the graph. This indicates the global connectivity has the size n by n. The term clique represents a group of nodes that are fully connected to each other. In one embodiment, a clique is an array of integers. The elements of the array are values 0 or 1. The position of the element represents the number of the node. If a particular element has a value 0, this indicates that the node is not in the mesh. If it is 1, this indicates the node is in the mesh. Consider the following clique:

| 0 | 1 | 1 | 0 | 1 | 1 | 0 |
|---|---|---|---|---|---|---|
| 1 | 2 | 3 | 4 | 5 | 6 | 7 |

In this clique, nodes 2, 3, 5, and 6 are in the mesh.

One exemplary process to find the maximal fully connected group of nodes from the network of FIG. 3 starts with node 1. It is checked whether node 2 is connected to node 1. Node 1 and node 2 are connected and thus are a fully connected group. A new candidate node, in this case, node 3, is checked to see whether it forms a fully connected group with nodes 1 and 2. Node 3 does form a fully connected group with nodes 1 and 2. It is then checked to determine whether node 4 interconnects with each of nodes 1, 2 and 3. Node 4 does not interconnect with all of these nodes. Since there are no other additional candidate nodes, the group of nodes 1, 2 and 3 are indicated as being at a maximal mesh. Since each of the nodes in the mesh {1, 2, 3} are fully interconnected, each of the subgroup of nodes in the mesh are fully connected.

There may be another maximal mesh which includes some of the nodes of the mesh {1, 2, 3}. Other candidate nodes outside of the mesh are tested with subgroups of the mesh to determine if they form another mesh. In this case, the subgroup of nodes 1 and 3 can be added to candidate node 4 to form a maximal mesh {1, 3, 4}. Thus, two maximal meshes, meshes {1, 2, 3} and mesh {1, 3, 4} are determined.

The exemplary pseudocode below describes an exemplary way of determining maximal meshes. “Rclique” is a recursive function that is called to determine the maximal meshes. “CurrentLevel” represents the current node from which the execution of the routine Rclique begins. “CurrentClique” is the newest clique (mesh) that is being found. A mesh is stored as an array of node indices similar to the clique structure above. This mesh will in turn be a part of a global array of maximal meshes. An example of a general process for determining maximal meshes, using a matrix of node connections, is as follows:

```
Rclique( currentLevel)
{
  If (currentLevel > n)
  {
    if (size of the current clique >= 3)
    {
      if (the current clique changed in this recursive flow)
      {
        create a new mesh object
        check if this mesh is a subset of an existing mesh
        If no then
          store it in the global array of meshes
        Else
          Free the mesh
      }
    }
    Set current clique changed variable to 0 (basically reinitialize for
    the next run)
    Return from this run
  }
  Check if the node at currentLevel is connected to everyone in the
  current clique
  If yes then
  {
    Add this node to the current clique
    Increase size of Current Clique by 1
    Mark the current clique as having changed
    Call Rclique (currentLevel + 1)
    Reduce size of current clique by 1 since we have taken care of the
    currentLevel
  }
  Remove the currentLevel node from the currentClique by setting the
  array element for the
  node to 0
  Call Rclique(currentLevel + 1)
}
```

In the above example, Rclique is a recursive function. If all of the possible candidate nodes have been checked (currentLevel>n), then the size of the current clique is tested. If the size of the current clique is greater than 3, it is tested to see whether the clique had changed in this recursive flow. If so, a new mesh object is created. Next, it is checked if the mesh is a subset of an existing mesh. If not, the new mesh is stored in an array of meshes. Otherwise the new mesh is not stored (i.e., it is “freed”) in the array of meshes.

In an exemplary embodiment, maximal meshes are stored. If the new mesh is a subset of an existing mesh, the clique change variable is set to 0 to reinitialize for the next run and Rclique returns. It is checked whether the node of the current level is connected to everyone in the current clique. If so, the node is added to the clique and Rclique is recursively called. After the return from the recursive call of Rclique, the size of the current clique is reduced by one. If the node isn't connected to all other nodes in the current clique, the current level node is removed from the current clique by setting the array element to node 0. After the removal of the node from the current clique, Rclique is recursively called.

The recursive process steps through each of the possible meshes. However, those skilled in the art will appreciate that the computer program need not be a recursive function. Rather, recursive functions are an exemplary way to check possible mesh combinations.

Networks, such as computer networks, can contain a large number of network nodes. For example, where 20,000 or more network nodes are used, the connection matrix would likely be large, but sparse, since the number of connections for any one node would likely be less than 20,000.

In alternate embodiment, rather than using a connection matrix, indications of nodes that are connected to specific nodes can be stored as a list (e.g., a list of identifiers for each node which indicates those nodes which are connected to each node). In this way, the memory requirements for the topology information can be reduced.

In one example, the computer network topology discovery can also identify (e.g., find) network interfaces rather than network nodes. The computer network discovery operation can determine the connectivity of these interfaces. Network nodes can be considered to act as containers which collect sets of related interfaces. These interfaces can be managed as a group and defined by a single SNMP agent.

In one embodiment, the connectivity of interfaces is determined and this interface information can be used to determine node connectivity information. In the example of FIG. 3, the interconnection between the interfaces is collected. That is, information can be collected which indicates that interface 1 of node 1, connects with interface 1 of node 3, and so on. This interface information can be collected to ensure that interface 1 at node 1 indicates that it connects to interface 1 of node 3, and that 1 of node 3 indicates that it connects to interface 1 of node 1. This double-checking can avoid errors in a Management Information Base (MIB) stored, for example, at one of the interfaces.

The topology information can be received in any order. In FIG. 3, if a report from interface 1 of node 1 is received saying that it connects to interface 1 of node 3, a record is produced saying that there is a potential connection between the two interfaces. Once a report is received from the interface 1 of node 3 confirming this connection, the interface connection can be confirmed and indicated as correct.

In an exemplary embodiment, the interface connections are stored as a list for each interface (e.g., for each interface, a list of identifiers can indicate those interfaces to which each interface connects). An array of interface connection information lists can be created which will allow the construction of node connection information.

Once the interface connections are determined, the node connections can be found. In FIG. 3, node 1 has interfaces 1, 2, and 3. Then, a determination is made of those interfaces to which node 1 connects. In this case, the connected interfaces include interface 1 of node 3, interface 1 of node 4, and interface 2 of node 2. Thus, it is found that node 1 connects to nodes 2, 3 and 4. Indications of nodes 2, 3 and 4 are then added to a node connection list. The list can also include indications of nodes that are not confirmed to be connected, but there is some evidence of a connection (e.g., where a first interface indicates it is connected to another interface but the other interface does not confirmed that it is connected to the first interface; that is, partial evidence of a connection).

A computer program to find the maximal meshes can use the lists of the connected nodes. Looking again at FIG. 3, such a computer program can start at node 1 and go to the first indication in the list of connected nodes of node 1. In this case, the first indication in the list is node 2. Since node 1 and node 2 interconnect, they form a fully connected group. The second connected node for node 1 is then checked. In this case, the second connected node for node 1 is node 3. Node 3 interconnects with nodes 1 and 2, so node 3 is added to the fully connected group. The third node connected to node 1 is node 4 which is checked to see whether it connects with each of nodes 1, 2, and 3. Since node 4 does not connect to node 2, it is not added to the clique. Since there are no more nodes in the list of connected nodes, it is determined that nodes 1, 2, and 3 are a maximal mesh.

Nodes can be removed from the clique and additional node interconnections determined. When node 2 is removed from the clique and node 4 is checked, it is determined that nodes 1, 3, and 4 form a mesh which, in this case, is a maximal mesh. The use of a list of connected nodes can reduce the number of candidate nodes to be examined and speed up the mesh discovery when, for example, the computer network has sparse connections.

As an alternate to the Rclique procedure already discussed, another example of pseudocode for mesh determination that uses lists of node connections rather than a matrix of connections is as follows:

Find All Switch Meshes

For all nodes,

Get next current node

Ensure that current node is valid and is a switch rather than a router

Get list of nodes connected to current node

Check each node in list for validity and to ensure that it is a switch

If current node connected to two or more qualified nodes

Run Recursive Clique Check (current node, current group, list of qualified connections, group changed indicator)

The Find All Switch Meshes procedure checks each node to ensure that the current node is valid and a switch rather than a router. In one embodiment, switches are examined for membership in a mesh. The list of nodes connected to the current node is obtained. Each node in the list is checked for validity to ensure it is a switch. If the current node is connected to two or more qualified nodes, the Recursive Clique Check procedure is run. An example of a procedure for the Recursive Clique Check, which can be used to identify the nodes of maximal meshes, is as follows:

Recursive Clique Check

(Test node

Current group

List of qualified connections

Group changed indicator)

if test node is connected to every node in current group set connected flag

If no nodes are in list of qualified connections set terminate flag

else

remove a node from list of qualified connections

set removed node as the new node

create new current group consisting of test node added to current group

set group changed indicator

if connected flag set

if terminate flag set

Terminate Mesh Recursion (new current group, group changed indicator)

Else

Recursive Clique Check (new node, new current group, list of qualified connections, group changed indicator)

if terminate flag set

Terminate Mesh Recursion (current group, group changed indicator)

Else

Recursive Clique Check (new node, current group, list of qualified connections, group changed indicator)

When the Recursive Clique Check is first called, the current node is set as a test node. If the test node is connected to every node in the current group a connected flag is set. If there are no nodes in the list of qualified connections, a terminate flag is set. Otherwise, a node is removed from the list of qualified connections and the removed node is set as the new node. A new current group is created with the test node being added to the old current group, and the group change indicator is set.

If the connected flag is set, a first call is performed. If the terminate flag is set, the procedure Terminate Mesh Recursion is called using the new current group rather than the old current group. Otherwise, the procedure Recursive Clique Check is called using the new current group rather than the old current group.

When either of these calls returns or if the connected flag is not set, a second call is made. If the terminate flag is set, the Terminate Mesh Recursion Procedure is called using the current group rather than the new current group. Otherwise, the Recursive Clique Check is called using the current group rather than the new current group.

An example of a Terminate Mesh Recursion procedure, used to identify a maximal mesh, is as follows:

Terminate Mesh Recursion

(test group,

group changed indicator)

If test group size is less than three

clear group change indicator

return

else

if test group is a subset of a previous mesh

clear group changed indicator

return

else

add test group to set of meshes

Pursuant to the Terminate Mesh Recursion procedure, if the test group size is less than 3, the test group cannot be a mesh. In this case, the group change indicator is cleared and the procedure returns. Otherwise, if the test group is a subset of a previous mesh, the group change indicator is cleared and the system returns. Meshes that are found that are subsets of other meshes are not added as the new mesh. Otherwise, the test group is added to the set of meshes.

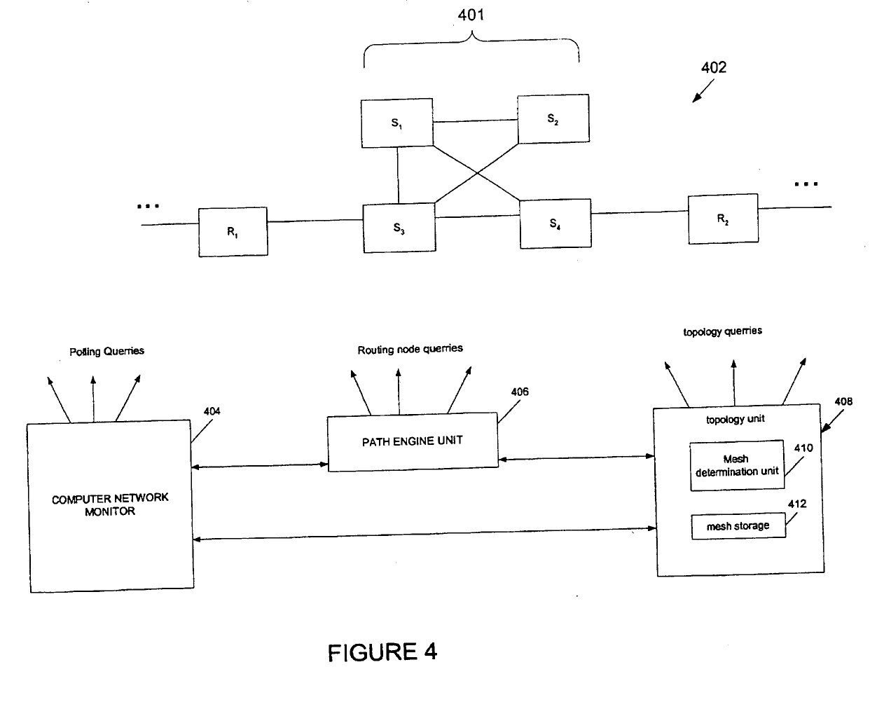

FIG. 4 is a diagram that illustrates a system adapted for mesh determination. In the example of FIG. 4, a computer network 401 includes switches S₁, S₂, S₃, and S₄ located between routers R₁ and R₂ in a larger computer network 402. A topology unit 408 produces topology queries to the interfaces of the switches S₁, S₂, S₃ and S₄. The topology unit 408 receives interface information in response to the queries. The topology unit 408 uses the interface information to create node (topology) information concerning the interconnection of the nodes S₁, S₂, S₃ and S₄. The topology information is evaluated to determine the meshes within the computer network. In this example, the meshes S₁, S₂, S₃ and S₄ are determined.

Mesh information, or data, is stored in the mesh storage 410. A path engine unit 406 can use the mesh data to produce path information between nodes. The path engine unit 406 can be used to determine a path through a larger computer network 402. For example, the path through nodes R₁, S₃, S₄, and R₄ can be determined. Although the path engine unit 406 is described herein for purposes of understanding exemplary embodiments, additional features of an exemplary path engine unit are described in the U.S. patent application Walker, et al. “Method of Indicating a Path in a Computer Network”, Ser. No. ______, (Attorney Docket No. 102202822-1).

Once a path is determined, it can be examined for stored mesh data to determine whether any of the connections in the path are part of a mesh. In this case, the connection between nodes S₃ and S₄ is part of a mesh and this mesh indication can be added as part of the path information. The mesh data allows the path information to indicate multiple paths. In the FIG. 4 example, the path information can be sent to a computer network monitor 404 which can use the path information to help determine a network failure within the larger computer network 402.

The mesh data can distinguish between internal and external interfaces to the mesh. In the FIG. 4 example, the interface on S₃ that connects to S₄ is an internal interface to the mesh. The failure of this interface can be avoided by reconfiguring the switching nodes (e.g., in a new spanning tree). For example, when the computer network 404 uses a spanning tree algorithm and the failed mesh interface is in the current spanning tree, the spanning tree algorithm can modify the spanning tree to avoid the failure at the interface for internal nodes of the mesh.

The interface on S₃ that connects to R₁ is an external interface of the mesh. In the FIG. 4 example, this external interface cannot be avoided by reconfiguring the switches.

In one example, meshes can be treated as objects having external interfaces. An example of such a mesh storage system is described in the U.S. patent application “METHOD OF STORING DATA CONCERNING A COMPUTER NETWORK”, Ho et al., Ser. No. ______ (Attorney Docket No. 100204008) incorporated herein by reference.

In the FIG. 4 example, meshes within a switching node portion of the larger computer network 402 are found, and meshes are defined in such a manner that they do not cross routing node borders (i.e., in an exemplary embodiment, meshes do not include routing nodes). In FIG. 4, the path engine unit 406 is used to determine a route of packets through the system. The route of packets through the system is set by the routing tables. For example, the route may pass through routers R₁ and R₂. Within the computer network 401 switching nodes that do not use routing tables, but may use a spanning tree are located between routing nodes R1 and R2. The current spanning tree can be subject to change, such as during an interface failure. The stored mesh data allows the computer network monitor to better understand the aspects of a failure of an interface on one of the nodes in computer network 404 (e.g., distinguish primary versus non-primary failures).

In the example of FIG. 4, the path engine unit 406 can query routing nodes (e.g., query the MIBs of each routing node) for interconnection information. The computer network monitor 404 can query, or poll, the MIBs of routing and/or non-routing nodes to determine connection information. The computer network monitor 404, path engine unit 406, and topology unit 408 need not be included among the computer network 401 of switches S₁, S₂, S₃ and S₄. The computer network monitor 404, path engine unit 406, and topology unit 408 can be located elsewhere in single or multiple computers. For example, the topology unit 408 can be located in the same or a different computer as the path engine unit 406 or the computer network monitor 404.

The foregoing methods can be implemented in a computer readable medium containing a computer program for performing the functions described herein.

It will be appreciated by those of ordinary skill in the art that the invention can be implemented in other specific forms without departing from the spirit or character thereof. The presently disclosed embodiments are therefore considered in all respects to be illustrative and not restrictive. The scope of the invention is illustrated by the appended claims rather than the foregoing description, and all changes that come within the meaning and range of equivalents thereof are intended to be embraced herein.

What is claimed is:

1. A method of determining a maximal mesh comprising:
examining topology information to determine multiple, maximal meshes in a network; and
storing mesh data that indicates the multiple, maximal meshes.

2. The method of claim 1, wherein the network is a computer network containing routing nodes and non-routing nodes.

3. The method of claim 1, comprising:
obtaining topology information that indicates which nodes in the computer network are interconnected.

4. The method of claim 1, wherein a candidate node is evaluated to determine whether the candidate node interconnects with all nodes in a fully connected group of nodes.

5. The method of claim 4, wherein when the candidate node interconnects with all the nodes in the fully connected group of nodes, the candidate node is added to the fully connected group.

6. The method of claim 4, wherein when no other node can be added to the fully connected group and there are at least three nodes in the fully connected group, the fully connected group is indicated as a maximal mesh.

7. The method of claim 4, wherein the fully connected group is evaluated to determine whether it is a subset of a mesh.

8. The method of claim 1, wherein the examining of the topology information is performed by a computer program.

9. The method of claim 8, wherein the computer program uses recursion.

10. The method of claim 8, wherein the computer program keeps track of multiple fully- connected groups.

11. A computer system for determining a maximal mesh comprising:
means for examining topology information concerning a network to determine multiple, maximal meshes in a network; and
means for storing mesh data that indicates the multiple, maximal meshes.

12. The computer of claim 11 wherein the network is a computer network.

13. The computer of claim 11 wherein the examining means is configured to receive topology information that indicates which nodes in the network are interconnected.

14. The computer of claim 11, wherein the examining means is configured to evaluate a candidate node to determine whether the candidate node interconnects with all nodes in a fully connected group of nodes.

15. The computer of claim 14, wherein when the candidate node interconnects with all the nodes in the fully connected group of nodes, the candidate node is added to the fully connected group.

16. The computer of claim 14, wherein when no other node can be added to the fully connected group and there are at least three nodes in the fully connected group, the fully connected group is indicated as a maximal mesh.

17. The computer of claim 14, wherein the fully connected group is evaluated to determine whether it is a subset of a mesh.

18. The computer of claim 14, wherein the examining means executes a computer program, which uses recursion.

19. The computer of claim 14, wherein the examining means keeps track of multiple fully- connected groups.

20. A computer readable medium comprising a program which executes the following procedure for determining a maximal mesh:
examining topology information to determine maximal meshes in a network; and
storing mesh data that indicates the multiple, maximal meshes.

21. The computer readable medium of claim 20, wherein the network is a computer network containing routing nodes and non-routing nodes.

22. The computer readable medium of claim 20, wherein the procedure comprises:
obtaining topology information that indicates which nodes in the computer network are interconnected.

23. The computer readable medium of claim 20, wherein a candidate node is evaluated to determine whether the candidate node interconnects with all nodes in a fully connected group of nodes.

24. The computer readable medium of claim 23, wherein when the candidate node interconnects with all the nodes in the fully connected group of nodes, the candidate node is added to the fully connected group.

25. The computer readable medium of claim 23, wherein when no other node can be added to the fully connected group and there are at least three nodes in the fully connected group, the fully connected group is indicated as a maximal mesh.

26. The computer readable medium of claim 23, wherein the fully connected group is evaluated to determine whether it is a subset of a mesh.

27. The computer readable medium of claim 23, wherein the examining of the topology information is performed by a computer program.
